(19) United States
(12) Patent Application Publication
(10) Pub. No.: US 2011/0215915 A1
(43) Pub. Date: Sep. 8, 2011

(54) DETECTION SYSTEM AND DETECTING METHOD FOR CAR

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/816,338

(22) Filed: Jun. 15, 2010

(30) Foreign Application Priority Data
Mar. 2, 2010 (CN) 201010116110.6

(51) Int. Cl. B60Q 1/00; H04N 7/18

(52) U.S. Cl. 340/435; 348/148

(57) ABSTRACT

A detection system used for a car includes a number of time-of-flight (TOF) cameras and a processing unit. The TOF cameras capture images and obtain distance data between objects near the car and the TOF cameras. The processing unit receives the images and the distance data to determine a speed of each object moving toward the car. The processing unit further warns a driver of the car when a speed of one object moving toward the car is faster than a preset speed.

### BACKGROUND

1. Technical Field

The present disclosure relates to a detection system and a detecting method for a car.

2. Description of Related Art

Seat belts and airbags are designed to reduce injuries when an automobile collides with another automobile or with other stationary objects. However, these automotive safety products are used when an accident occurs and do not help with avoiding accidents. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of a car with an embodiment of a detection system.

FIG. 2 is a block diagram of a first embodiment of a detection system including a storage unit.

FIG. 3 is a block diagram of a first embodiment of the storage unit of FIG. 2.

FIG. 4 is a block diagram of a second embodiment of the storage unit of FIG. 2.

FIG. 5 is a flowchart of a first embodiment of a detecting method.

FIG. 6 is a flowchart of a second embodiment of a detecting method.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

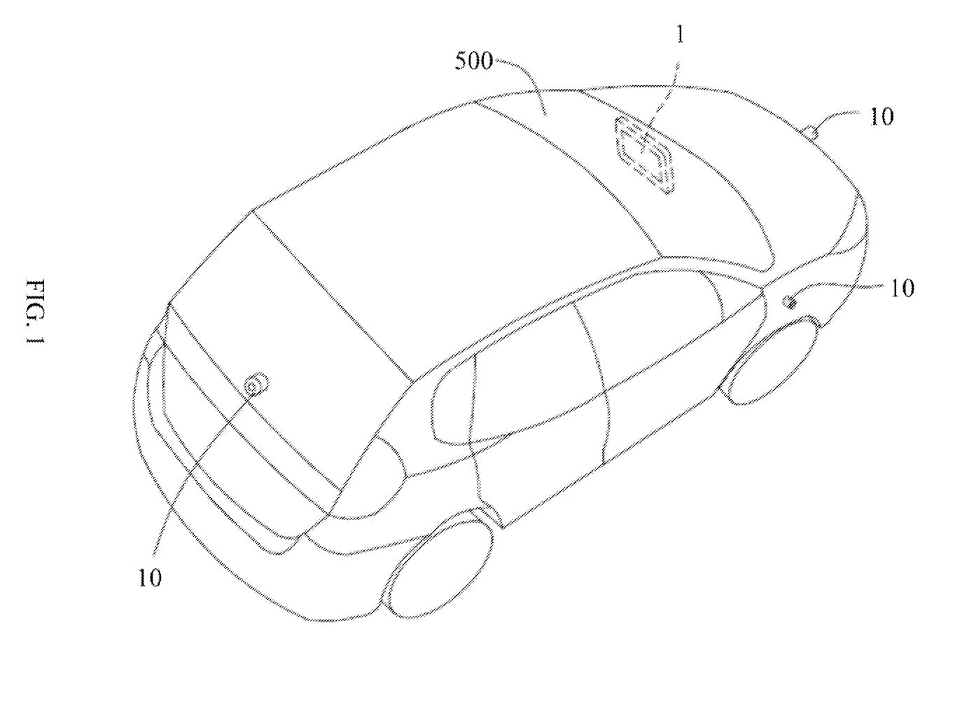

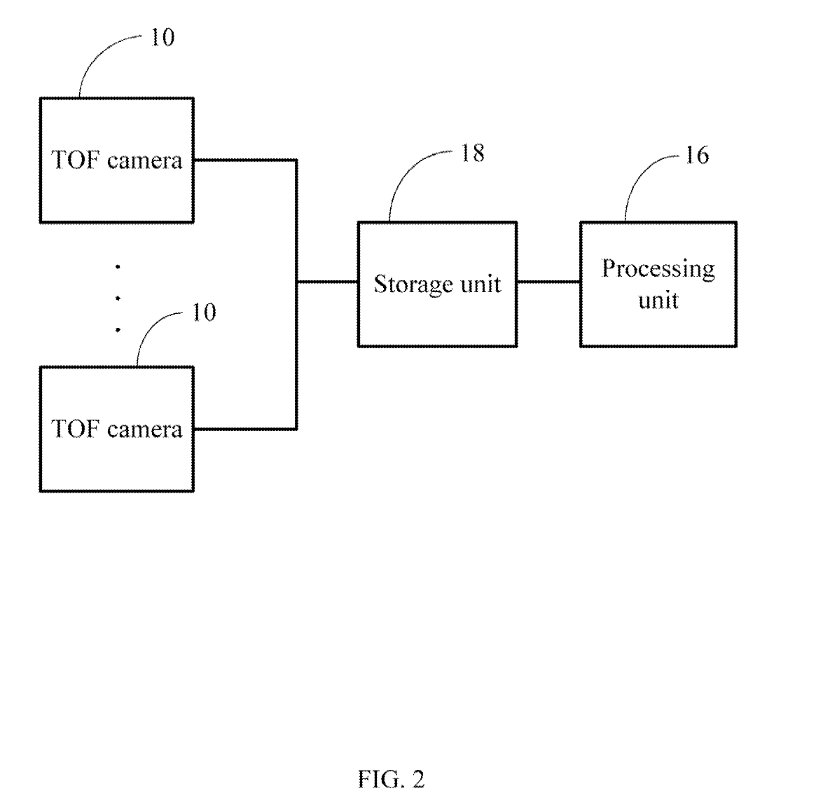

Referring to FIGS. 1 and 2, a first embodiment of a detection system 1 includes a plurality of time-of-flight (TOF) cameras 10, a processing unit 16, and a storage unit 18. The detection system 1 is used with a car 500 to monitor objects near the car 500, and warn a driver or automatically control the car 500 correspondingly.

The plurality of TOF cameras 10 are arranged on the top, the left side, the right side, the front side, and/or the back side of the car 500. Each TOF camera 10 captures an image, and obtains distance data between a plurality of points on an object and the TOF camera 10. When the TOF camera 10 films the object, the TOF camera 10 emits signals, such as infrared, to the object. The signals are reflected back to the TOF camera 10 when they meet a surface of the object. As a result, the distance data can be obtained according to a time difference between sending and receiving the signals of the TOF camera 10.

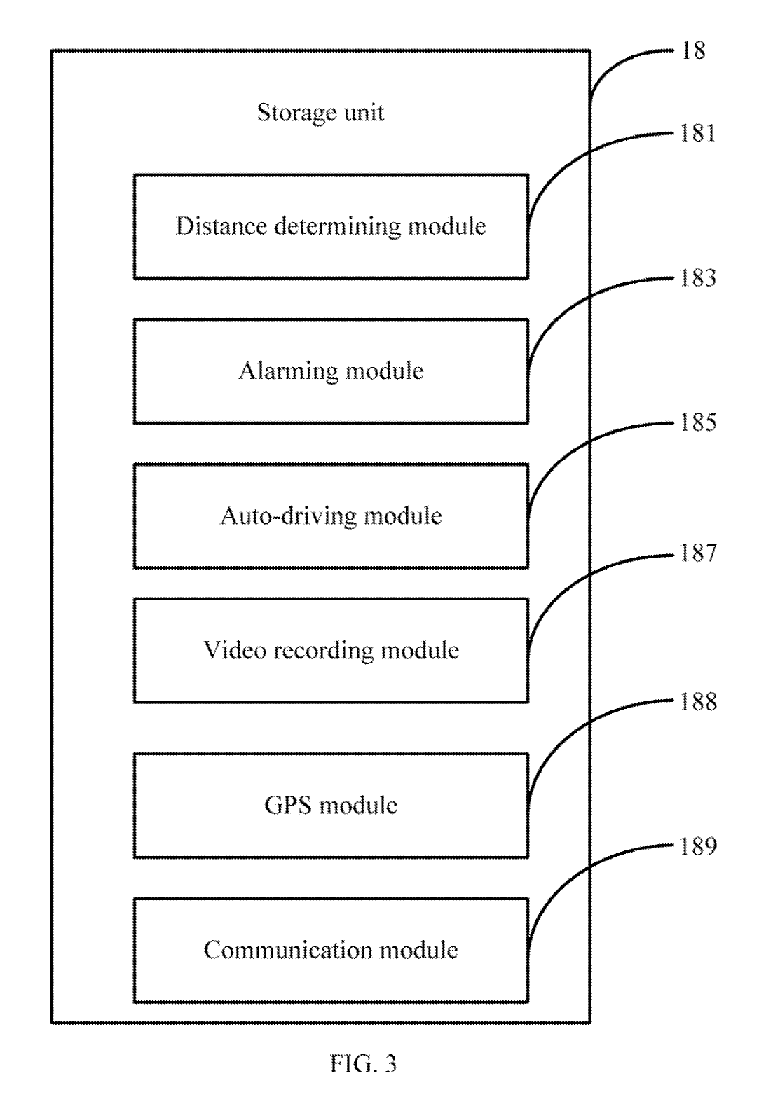

Referring to FIG. 3, the storage unit 18 includes a distance determining module 181, an alarming module 183, an auto-driving module 185, a video recording module 187, a global position system (GPS) module 188, and a communication module 189. The distance determining module 181, the alarming module 183, the auto-driving module 185, the video recording module 187, the communication module 189, and the GPS module 188 is a GPS personal tracking module and may include one or more computerized instructions and are executed by the processing unit 16.

The distance determining module 181 receives images and distance data from the plurality of TOF cameras 10, and determines a speed of an object moving toward the car 500. In the embodiment, the distance determining module 181 may obtain the distances between the object and the car 500 at different times from the TOF camera 10. With the distances and the times, the speed can be obtained according to a formula of V=S/t, wherein V stands for a speed, S stands for a distance, and t stands for a time. In addition, when the speed of the object moving toward the car 500 is faster than a preset speed, the object is regarded as a threat or a potential cause of collision.

The alarming module 183 warns the driver when there is a threat near the car 500. In one embodiment, the alarming module 183 may alarm to warn the driver that there is a threat moving toward the car 500.

The auto-driving module 185 automatically steers the car 500 to avoid the threat when there is a threat near the car 500. In other embodiments, the auto-driving module 185 can be omitted.

The video recording module 187 records the threat to obtain a video. If an accident has occurred, the video can be used in investigating the cause of the accident.

The GPS module 188 provides location information of the car 500, such that if there is an accident with the car 500, the GPS module 188 can transmits the location information of the car 500 to the rescue centre via the communication module 189.

The detection system 1 determines whether a threat is near the car 500 according to the speed of the objects moving toward the car 500. Upon the condition that there is a threat near the car 500, the detection system 1 warns the driver or automatically steers the car 500 to avoid an accident. In addition, the detection system 1 also captures the threat on video. If an accident has occurred, the video can be used in investigating the cause of the accident The GPS module 188 further provides the location information of the car 500 to the rescue centre via the communication module 189.

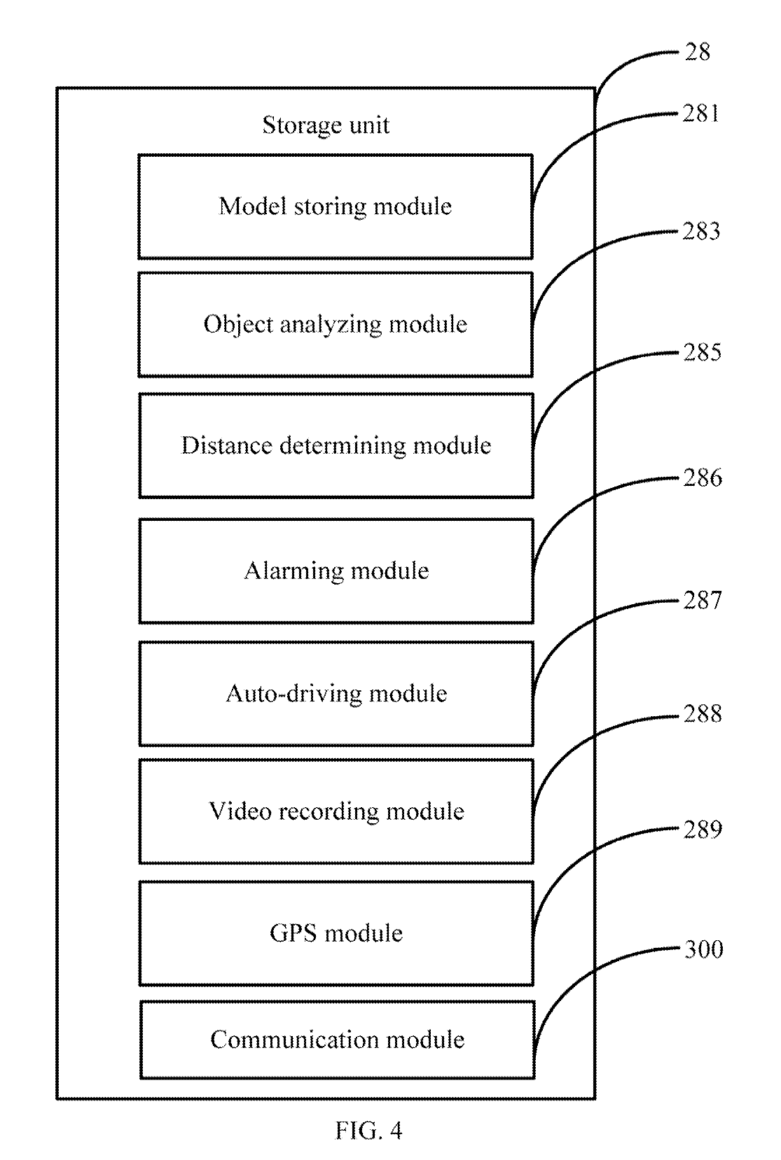

Referring to FIG. 4, in a second embodiment, a storage unit 28 includes a model storing module 281, an object analyzing module 283, a distance determining module 285, an alarming module 286, an auto-driving module 287, a video recording module 288, a global position system (GPS) module 289, and a communication module 300.

The model storing module 281 stores a plurality of three dimensional (3D) models of different objects, such as a plurality of different cars, and a plurality of different rocks.

The object analyzing module 283 obtains 3D models of objects near the car 500 according to the images and distance data from the TOF cameras 10. It can be understood that the object analyzing module 283 uses well known technology to obtain the 3D models according to the images and distance data. A determination is made to determine what type of objects are near the car 500 by comparing the obtained 3D models with the plurality of 3D models stored in the model storing module 281.

The alarming module 283 warns the driver of the type of the object near the car 500. For example, the alarming module 283 sounds to warn the driver that there is a rock near the car 500 when a rock is determined to be near the car 500.

The distance determining module 285, the alarming module 286, the auto-driving module 287, the video recording module 288, the GPS module 289, and the communication module 300 are the same as the distance determining module 181, the alarming module 183, the auto-driving module 185, the video recording module 187, the GPS module 188, and the communication module 189 of the storage unit 18 of the above-mentioned embodiment.

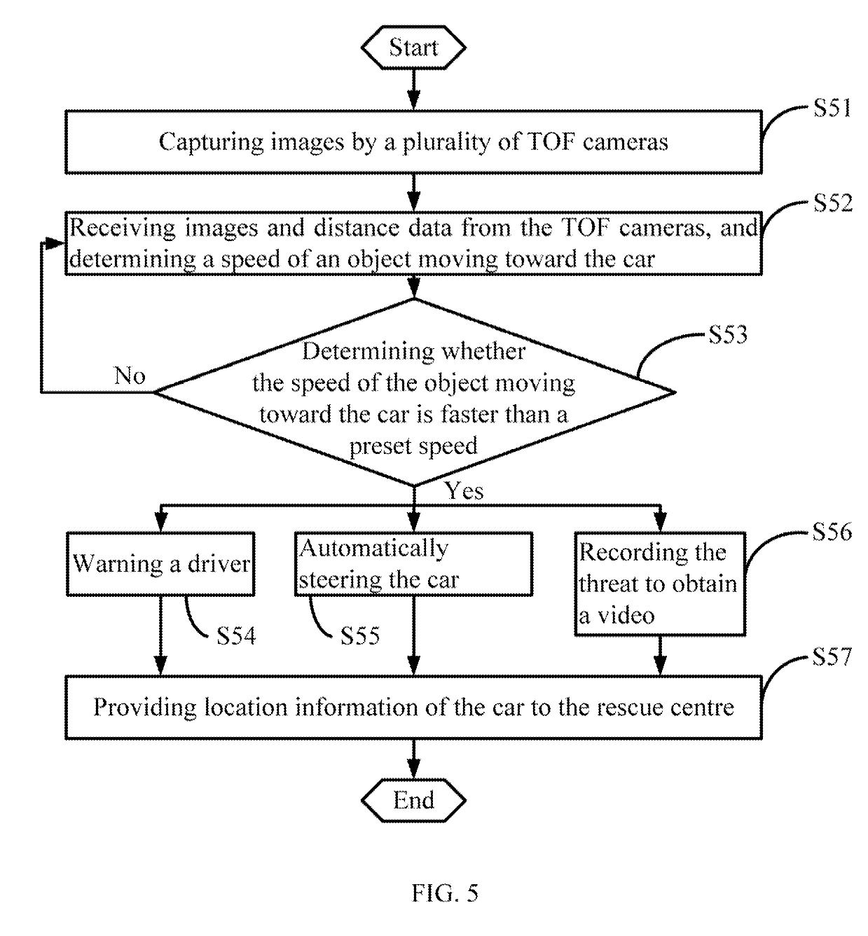

Referring to FIG. 5, a first embodiment of a detecting method includes the following steps.

In step S51, each TOF camera 10 captures images and obtains distance data between a plurality of points on an object and the TOF camera 10.

In step S52, the distance determining module 181 receives the images and distance data from the TOF cameras 10, and determines a speed of an object moving toward the car 500.

In step S53, a determination is made to determine whether the speed of the object moving toward the car 500 is faster than a preset speed. Upon the condition that the speed is faster than the preset speed, the object is regarded as a threat, the process goes to Steps S54, S55, and S56. Upon the condition that the speed is slower than the preset speed, the process returns to step S52.

In step S54, the alarming module 183 warns the driver that there is a threat near the car.

In step S55, the auto-driving module 185 automatically steers the car 500.

In step S56, the video recording module 187 records the threat to obtain a video. If an accident has occurred, the video can be used in investigating the cause of the accident.

In step S57, the GPS module 188 provides reliable location information of the car 500 to the rescue centre via the communication module 189.

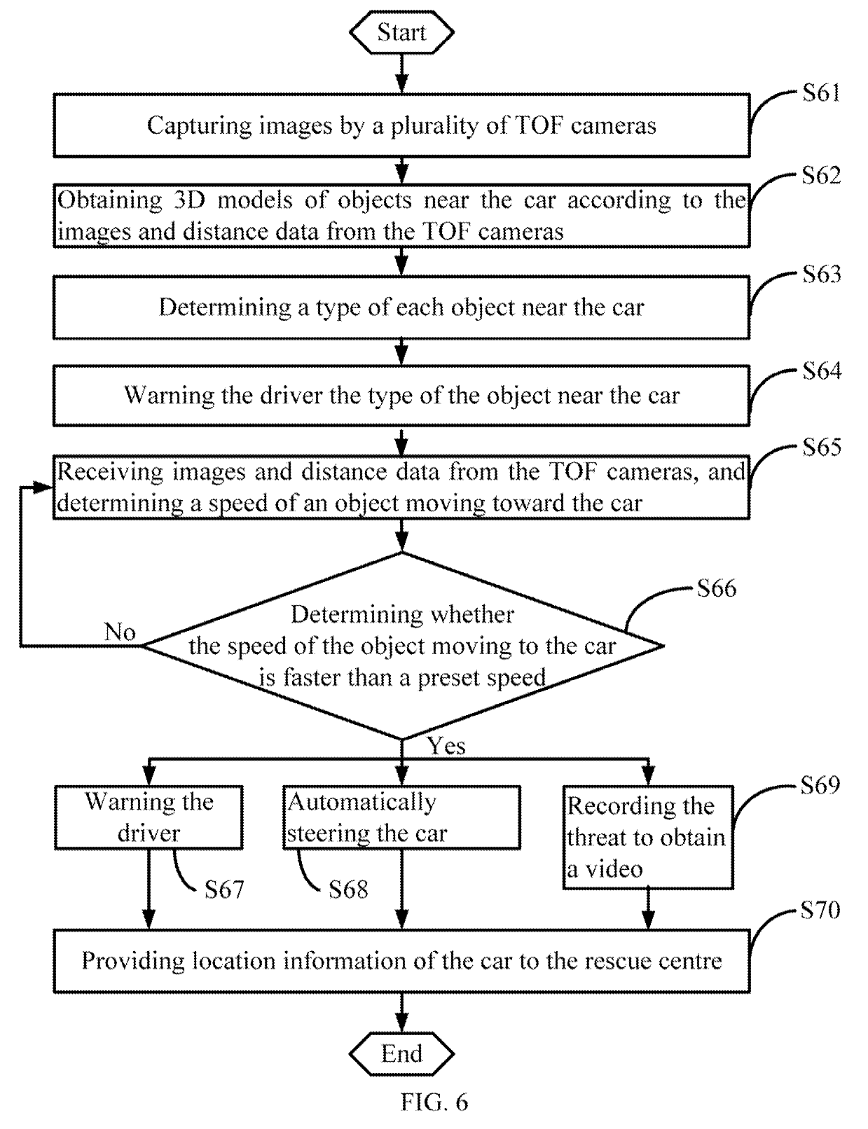

Referring to FIG. 6, a second embodiment of a detecting method includes the following steps.

In step S61, each TOF camera 10 captures images and obtains distance data between a plurality of points on an object and the TOF camera 10.

In step S62, the object analyzing module 283 obtains 3D models of the objects near the car 500 according to the images and distance data from the TOF cameras 10.

In step S63, what type of objects are near the car 500 is determined by comparing the obtained 3D models with a plurality of 3D models stored in the model storing module 281.

In step S64, the alarming module 283 warns the driver the type of the objects near the car 500.

In step S65, the distance determining module 285 receives images and distance data from the cameras 10, and determines a speed of each object moving toward the car 500.

In step S66, a determination is made to determine whether the speed of the object moving toward the car 500 is faster than a preset speed. Upon the condition that the speed is faster than the preset speed, the object is regarded as a threat, the process goes to steps S67, S68, and S69. Upon the condition that the speed is slower than the preset speed, the process returns to step S65.

In step S67, the alarming module 286 warns the driver that there is a threat near the car.

In step S68, the auto-driving module 287 automatically steers the car 500.

In step S69, the video recording module 288 records the threat to obtain a video. If an accident has occurred, the video can be used in investigating the cause of the accident.

In step S70, the GPS module 289 provides reliable location information of the car 500 to the rescue centre via the communication module 300.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A detection system used for a car, the detection system comprising:
a plurality of time-of-flight (TOF) cameras being mounted on the car to capture images and obtain distance data between a plurality of objects near the car and the plurality of TOF cameras;
a processing unit; and
a storage unit connected between the processing unit and the TOF cameras, and storing a plurality of programs to be executed by the processing unit, wherein the storage unit comprises:
a distance determining module to receive the images and distance data from the plurality of TOF cameras, and determine a speed of each object moving toward the car; and
an alarming module to warn a driver of the car when a speed of one object moving toward the car is faster than a preset speed.

2. The detection system of claim 1, wherein the storage unit further comprises an object analyzing module, the object analyzing module obtains three dimension (3D) models of each object near the car according to the images and distance data from the plurality of TOF cameras, and determines a type of each object near the car by comparing the obtained 3D models with a plurality of 3D models stored in the storage unit.

3. The detection system of claim 2, wherein the alarming module further warns the driver of the car about the type of each object.

4. The detection system of claim 1, wherein the storage unit further comprises an auto-driving module, the auto-driving module automatically steers the car when the speed of one object moving toward the car is faster than the preset speed.

5. The detection system of claim 1, wherein the storage unit further comprises a video recording module, the video recording module records the object which has a speed faster than the preset speed to obtain a video.

6. The detection system of claim 1, wherein the storage unit further comprises a global position system (GPS) module and a communication module, the GPS module provides location information of the car to a rescue centre via the communication module.

7. A detecting method used for a car, the detecting method comprising:
capturing images and obtaining distance data between a plurality of objects near the car and a plurality of time-of-flight (TOF) cameras mounted on the car by the plurality of TOF cameras;
receiving the images and distance data from the plurality of TOF cameras;
obtaining a speed of each object moving toward the car;
determining whether the speed of an object moving toward the car is faster than a preset speed; and
alarming a driver of the car upon the condition that a speed of one object is faster than the preset speed.

8. The detecting method of claim 7, between the step of “receiving the images and distance data from the plurality of TOF cameras” and the step of “obtaining a speed of each object moving toward the car”, further comprising:
obtaining a three dimension (3D) model of each object near the car according to the images and distance data from the plurality of TOF cameras; and
comparing the obtained 3D model with a plurality of 3D models to determine a type of each object near the car.

9. The detecting method of claim 7, after the step of “determining whether the speed of an object moving toward the car is faster than a preset speed”, further comprising:
recording the object which has a speed faster than the preset speed to obtain a video.

10. The detecting method of claim 7, further comprising:
providing reliable location information of the car to a rescue centre.
